(19) United States
(12) Patent Application Publication
(10) Pub. No.: US 2019/0066547 A1
(43) Pub. Date: Feb. 28, 2019

(54) Force-orienting Display System

(71) Applicant: Douglas Parker, Henderson, NV (US)

(72) Inventor: Douglas Parker, Henderson, NV (US)

(21) Appl. No.: 16/151,189

(22) Filed: Oct. 3, 2018

Related U.S. Application Data
(63) Continuation-in-part of application No. 14/568,128, filed on Dec. 12, 2014, now abandoned.

(51) Int. Cl. G09F 11/02

(52) U.S. Cl. CPC G09F 11/025

(57) ABSTRACT

A force-orienting display assembly comprising a number of display segments rotatably mounted on a movable surface, the display segments positioned proximally to each other, in a manner which reassembles picture segments to display a number of properly oriented, non-inverted pictures in a plurality of viewing orientations, where the mounting surface comprises a drum or a flat vertical surface is disclosed.

### CROSS-REFERENCE TO RELATED APPLICATION

This application claims the benefit of non-provisional patent application Ser. No. 14/568,128.

### FEDERALLY SPONSORED RESEARCH

Not Applicable

### SEQUENCE LISTING OR PROGRAM

Not Applicable

### BACKGROUND OF THE INVENTION

### Field of the Invention

The present invention relates generally to card, picture, or sign exhibiting devices that use forces to effect a common alignment of independent rotatably mounted display elements to display one or more pictures in upright orientations.

### Prior Art

Concrete mixer drums typically sport artwork featuring their company's logos or company names on them for marketing and advertising purposes. That artwork, physically applied to the outside of the drum, is properly displayed and oriented right-side up on one side of the mixing drum, but is upside-down on the opposite side of the drum.

The inverted logo and text, repeatedly employed over the years, has always been a Pink Elephant of that industry. Some attempts to work around the restrictions on the mode of display have been to eliminate all recognizable images, trademarks, names, and any text markings from the drum's surface, opting for solid colors or simple graphic designs which have no tops or bottoms. Other approaches have been to place copy on a text baseline located on a circumference of the drum, providing a somewhat readable message. Text on the circumference of the drum was readable and acceptable in that it was never inverted, being readable from both sides, but was used as merely a best case alternative as there was no way to provide for generally horizontally placed text to be displayed right-side up on both sides of the drum.

Any other placement of text on a concrete mixer drum at any orientation other than around its circumference will inevitably appear in an improper orientation, still somewhat readable, but angled and at some point in its rotation, inverted nonetheless.

A preferred solution to the inverted logo dilemma would be simple in design and simple in operation. The concrete hauling vehicles are heavy enough when empty. A solution should add minimal additional weight to the vehicle. Any solution has to be simple, lightweight, and self-sufficient.

Additionally, in an unrelated arena, point-of-purchase and point-of-sale display manufacturers are continually searching for ways to create attractive, interactive, or dynamic displays that are simple in operation and low in cost. Dynamic displays work because they attract people's attention and communicate more information in the same amount of space as a static display. If a way to create a dynamic display on a vertical surface were to be created which would be simple in construction and operation, it would provide yet another tool for the companies that are involved in the design and manufacture of displays for point-of-sale and point-of-purchase displays.

### Objects and Advantages

Accordingly, besides the objects and advantages of the invention described in this specification, several objects and advantages of the present invention are:

to provide an easily changeable force-orienting display system which provides alignment and display of an image segmented and mounted on receiver substrates on a number of display segments through the application of existing or applied forces;

to provide an easily changeable, inexpensive, dynamic advertising device for use in point-of-purchase and point-of-sale displays and others; and

to provide an easily changeable, segmented exhibitor display device which through the application of known or applied forces displays multiply sectioned images into their composite images through the employment of a common alignment scheme.

Further objects and advantages of my invention will become apparent from a consideration of the drawings and ensuing description.

### SUMMARY OF THE INVENTION

The present invention includes an easily changeable, or semi-permanent, force-orienting display system with a number of display segments positioned proximally to each other attached rotatably to movable supports and mounted to a moving surface. The materials used in construction of the display segments can include but are not limited to polymers, plastics, metals, or other materials which may be opaque, semi-transparent, or transparent. The weighted characteristic of the display segments implies that its center of balance is not colinear with the display segment's axis of rotation, guaranteeing alignment of all display segments due to the effect of gravity, or by similar argument if a force other than gravity is involved. The external surfaces of the multiple display segments have receiver substrate areas determined, and any number of images which are cut into image sections are applied to these receiver substrate areas in a variety of ways, including but not limited to painting, decals, hook and loop, slidable trays, sleeves, and other manners of attachment. As the mounting surface moves, the weighted display segments are acted on by gravity to effect a common alignment of each display segment with respect to each proximal display segment and also with respect to the mounting surface, showing common display faces on all display segments in such a manner as to display one or more pictures properly aligned top to bottom in a plurality of views. This allows for right side up orientation of logos lettering or images on two sides of a concrete mixer drum. Two images are displayed, one on each side of the concrete mixer drum.

In the drawings, closely related figures have the same number but different alphabetic suffixes.

### DRAWINGS—FIGURES

FIG. 1 shows a force-orienting display system comprising four elongated display elements of various lengths on a representative portion of a curved movable drum.

FIG. 2 shows a force-orienting display system comprising four elongated display elements of various lengths on a representative portion of a movable planar surface, with its vertical center of rotation as marked.

FIG. 3 shows an elongated display element whose axis of rotation is colinear with the center of the cylinder's axis.

FIG. 4 shows an elongated display element illustrating a representative way that different material densities can be used to manufacture display elements that have centers of balance that are not colinear with the axis of the cylinder.

FIG. 5 shows an elongated display element whose axis of rotation is offset from the central axis of its cylinder.

FIG. 6 shows a cutaway of an elongated display element illustrating a method of adding a force inducing mass to the inside of a display element.

FIG. 7 shows a display element illustrating how two different graphics are mounted to a left half and a right half of a display element, providing proper orientation of the two different graphics that will later be viewed in proper orientation in a plurality of views.

FIG. 8 shows a cutaway view of an elongated display segment with internal lighting devices for internal illumination.

FIG. 9 illustrates an elongated display segment displaying tongues used for slidably mounting removable curved picture section sleds.

FIG. 10 illustrates an elongated display segment with channels used for slidably attaching removable curved picture section sleds.

FIG. 11A illustrates a sample picture used in a force-orienting display system and its cut lines.

FIG. 11B illustrates a sample picture used in a force-orienting display system as well as its cut lines. FIG. 11B is the number “2” reversed, displaying into the page and away from the reviewer.

FIGS. 12A and 12B illustrate how the pictures in FIGS. 11A and 11B are cut into picture sections for mounting. FIG. 12B is the number “2,” displayed in sections and upside-down.

FIGS. 13A through 13D illustrate how the picture sections of FIGS. 12A and 12B relate to each other when applied to the mounting substrate areas defined on the display segments. The figures further illustrate a manner in which their picture sections can be recombined for attachment to display elements. FIG. 13A is comprised of element 242 and element 232, FIG. 13B is comprised of element 244 and element 234, FIG. 13C is comprised of element 246 and element 236, and FIG. 13D is comprised of element 248 and element 238.

FIG. 14 shows a relative positioning of FIGS. 11A and 11B when stacked back to back.

FIG. 15 illustrates picture segments 242 and 232 of FIG. 13A applied to the substrate area of elongated display segment 100. The solid black artwork is the front facing image segment of the “1” graphic, and the dashed line is the backward facing and reverse stacked image segment of the “2” graphic.

FIG. 16 illustrates picture segments 244 and 234 of FIG. 13B applied to the substrate area of elongated display segment 100. The solid black artwork is the front facing image segment of the “1” graphic, and the dashed line is the backward facing and reverse stacked image segment of the “2” graphic.

FIG. 17 illustrates picture segments 246 and 236 of FIG. 13C applied to the substrate area of elongated display segment 100. The solid black artwork is the front facing image segment of the “1” graphic, and the dashed line is the backward facing and reverse stacked image segment of the “2” graphic.

FIG. 18 illustrates picture segments 248 and 238 of FIG. 13D applied to the substrate area of elongated display segment 100. The solid black artwork is the front facing image segment of the “1” graphic, and the dashed line is the backward facing and reverse stacked image segment of the “2” graphic.

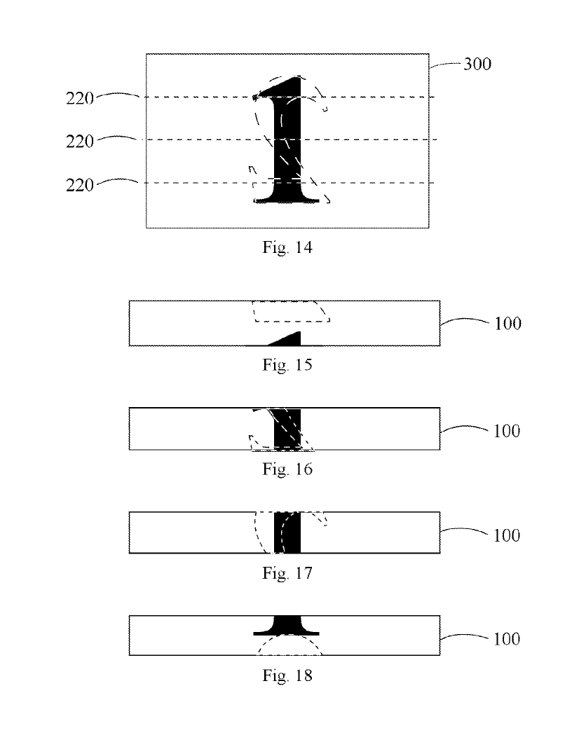

In FIGS. 15-18, when the top to bottom order is properly stacked for the correctly oriented, right side up display of image “1,” the stacking order for the display of dashed, image “2” graphic reassembly appears in its reverse order on the back, unseen side of the elongated display segments. They will reverse their stacking order when a different one of the unit's plurality of views comes into alignment.

### DRAWINGS—REFERENCE NUMERALS

10 force-orienting display system
20 force-orienting display system
100 display segment
101 mount (representative)
102 display segment cutaway edge
103 display segment cutaway edge
104 drum
105 light density material
106 dense material
107 flat representative surface
108 center of rotation
110 rotational mechanism
120 force inducing mass
122 force inducing mass front face
202 “1” picture
204 “2” picture
220 picture cut lines
230 “1” graphic
232 “1” picture section
234 “1” picture section
236 “1” picture section
238 “1” picture section
240 “2” graphic (reversed)
242 “2” picture section, upside-down
244 “2” picture section, upside-down
246 “2” picture section, upside-down
248 “2” picture section, upside-down
250 right side graphic section
260 left side graphic section
300 relative positioning of FIGS. 11A the “1” graphic and 11B the “2” graphic
310 internal illumination device
320 tongue
330 groove

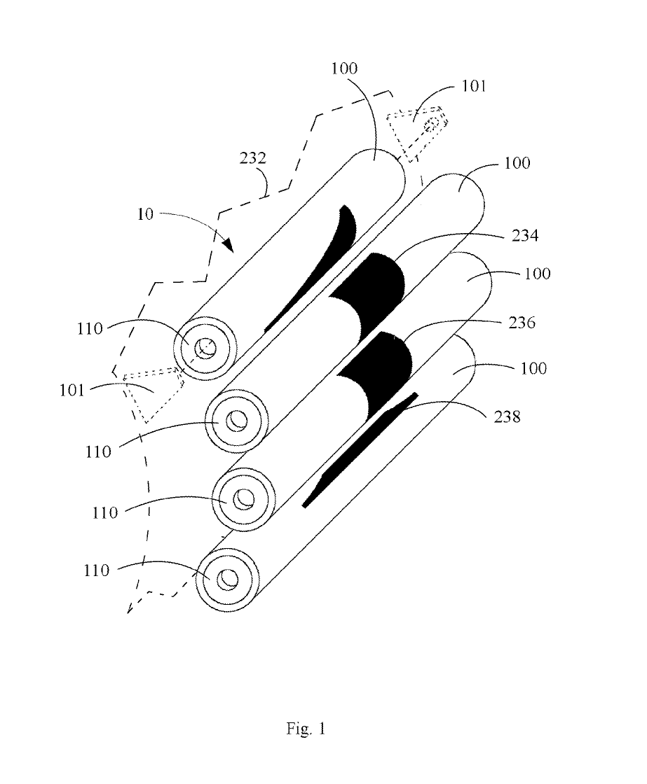

### DETAILED DESCRIPTION—FIG. 1—PREFERRED EMBODIMENT

The following terms will be used throughout the specification and will have the following meanings unless otherwise indicated.

“Picture” refers to artwork, a physical image, sign, graphic, or the like.

“Picture section” refers to a subportion of a picture that has been cut into smaller pieces.

“Graphic section” refers to a graphic or a portion of a graphic within a picture.

“Display segment” refers to an elongated display elements with defined receiver substrate areas on its exterior whose receiver substrate areas are used to mount picture sections.

The present invention includes a force-orienting display system for displaying a picture in right side up orientation in multiple viewing orientations. Comprising rotatable display segments, mounted proximally to each other on a movable drum surface, display segments each have receiver substrate areas established on their exteriors, any number of pictures can be displayed, having been cut into smaller picture sections, and mounted onto the receiver substrate areas. These are explained in greater detail in the following detailed description of the preferred embodiment.

In a preferred embodiment a force-orienting display system 10 of the present invention is illustrated in FIG. 1 showing multiple display segments 100 of any length, made from a hollow, lightweight plastic. In the preferred embodiment, the display segments are cylinders with circular cross-sections, though any cross section pattern allowing for free rotation of the display segments can be used. The mounts comprise a rotational mechanism, such as a conventional bearing 110, at both ends, allowing for smooth, unobstructed rotational movement of each display segment around its longitudinal axis.

The display segments are attached to two conventional mounts 101 attached to a surface 104 in such a way that the display segments are able to rotate freely on their longitudinal axis with respect to the mounting surface. The mounted display segments are proximally located to each other. Each display segment has sufficient length to define areas on its exterior as a receiver substrate for picture sections to be displayed.

The center of mass of each display segment is not colinear with its axis of rotation. FIG. 6 illustrates modifying the center of mass of a display segment by adding an internal mass 120, which may be made of a ferrous metal, lead, plastic, polymer, or other type of material suitable for use as an internal weight. FIG. 4 illustrates how materials of different densities can be used to create display segments with centers of mass non-colinear with their axes of rotation.

Receiver substrate areas for mounting picture sections are determined by examining a display segment at rest. Its orientation will have its center of balance below the axis of rotation. A plane through the axis of rotation and the resting center of balance defines a left and right receiver substrate area. Display segments displaying image segments mounted on their receiver substrate areas on the display segments are shown in FIGS. 15-18.

Pictures selected and cut into smaller picture sections are calculated to fit the physical dimensions of and are attached to the right side half and left side half receiver substrate areas defined.

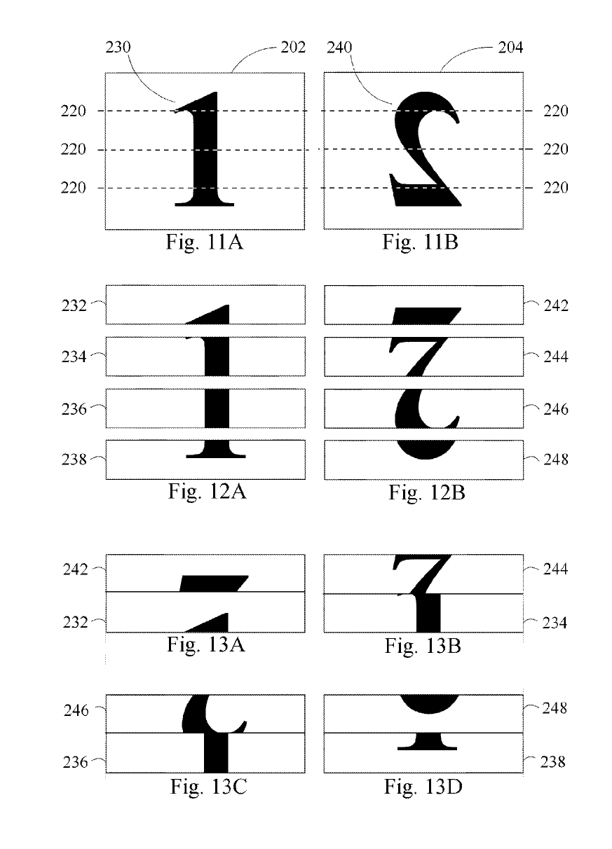

In a most preferred embodiment, the picture sections are printed onto the surface of curved, removable display sleds with semicircular cross sections extending the length of the display segments and slidably attached to a plurality of tongues 320 as illustrated in FIG. 9 through a corresponding lengthwise groove in the sled, or slidably attached to grooves 330 as illustrated in FIG. 10 through corresponding tabs or tongue along its lengthwise edges. FIGS. 11A, 11B, 12A, and 12B shows steps in the cutting of two pictures into picture segments. FIGS. 13A through 13D illustrate combining the picture sections from FIGS. 12A and 12B into multiple single sheet units which are then applied to multiple display segments 100 in FIGS. 15-18.

Whereas the picture segments from FIGS. 12A and 12B are used in FIGS. 13A through 13D, the picture segments from FIGS. 11A and 11B are used in FIGS. 15-18, showing the relationship of the different picture sections with respect to each other when attached to a display system of the current invention. Typically, one side of the force-orienting display system will display a picture to the viewer with its picture sections stacked in a sequentially correct order to display a picture visible to the viewer, as the “1” picture in FIGS. 15-18 show. The side facing away from the viewer will be displaying a stacking order in a reverse, inverted order. The hidden dashed lines of the “2” picture in FIGS. 15-18 illustrate this reversed stacking order.

### Operation—Preferred Embodiment

In its preferred embodiment, a display system as illustrated in FIG. 1 comprising any number of elongated display segments rotationally mounted to the outside surface of a moving surface such as a drum 104 and acted on by a known force such as gravity is presented. Each elongated display segment, having a receiver substrate area defined, will have picture segments attached to the substrate areas. The display segments 100 are positioned generally parallel to the drum's axis of rotation. A number of elongated display segments mounted sufficiently close to each other allow free rotation of all elongated display segments around the drum as the drum completes its full rotations, and as the drum rotates through 360°, the force acting on the elongated display segments will align all of the display segments in similar orientations to a viewer with respect to the surface of the drum, displaying a number of reconstructed pictures right side up on one side of the drum, and displaying a number of reconstructed pictures right side up on the opposite side of the drum, thus providing proper orientation for viewing in a plurality of orientations.

### Description—Alternate Embodiments

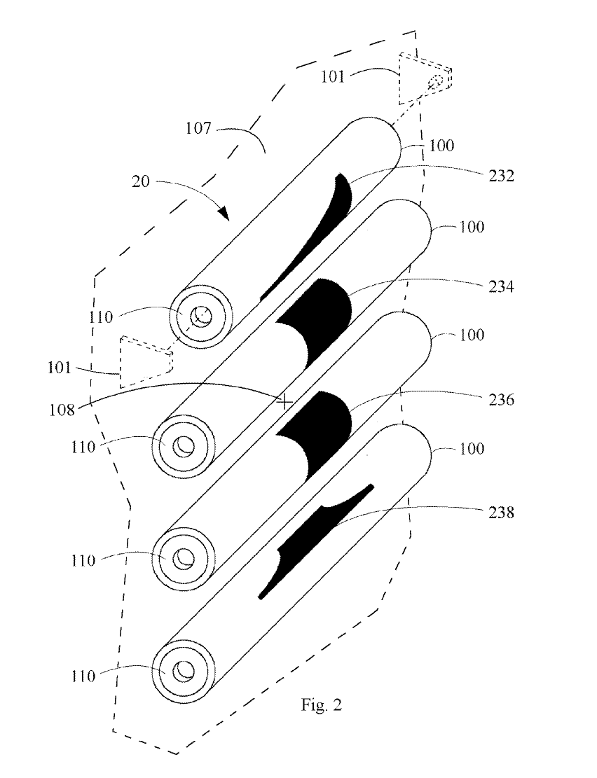

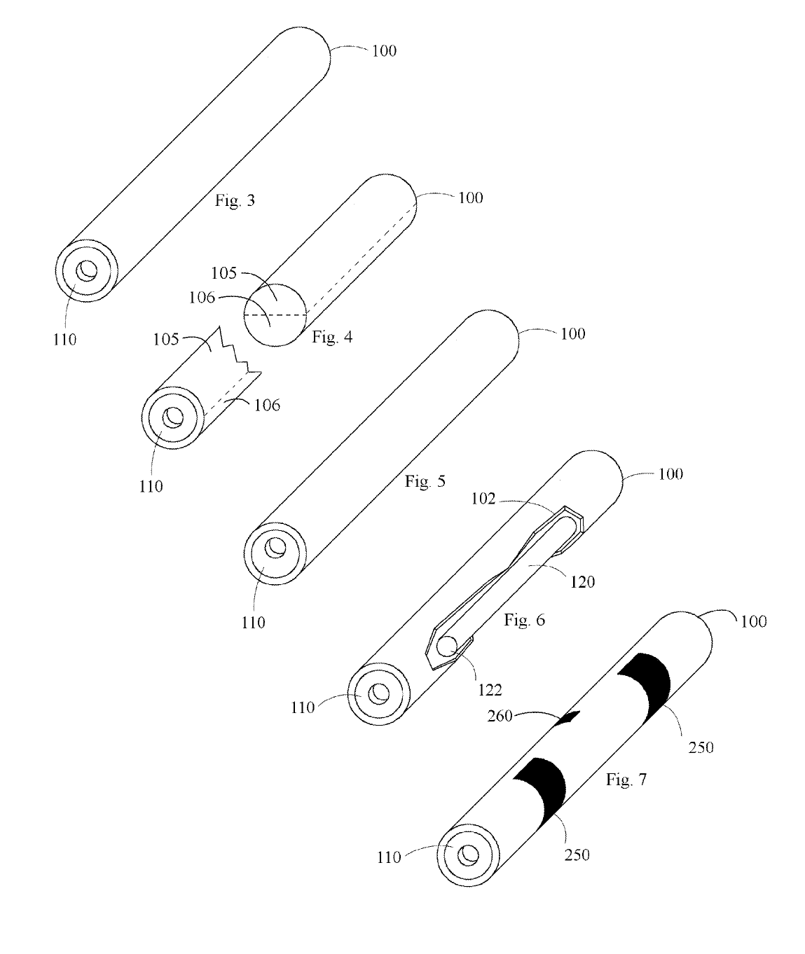

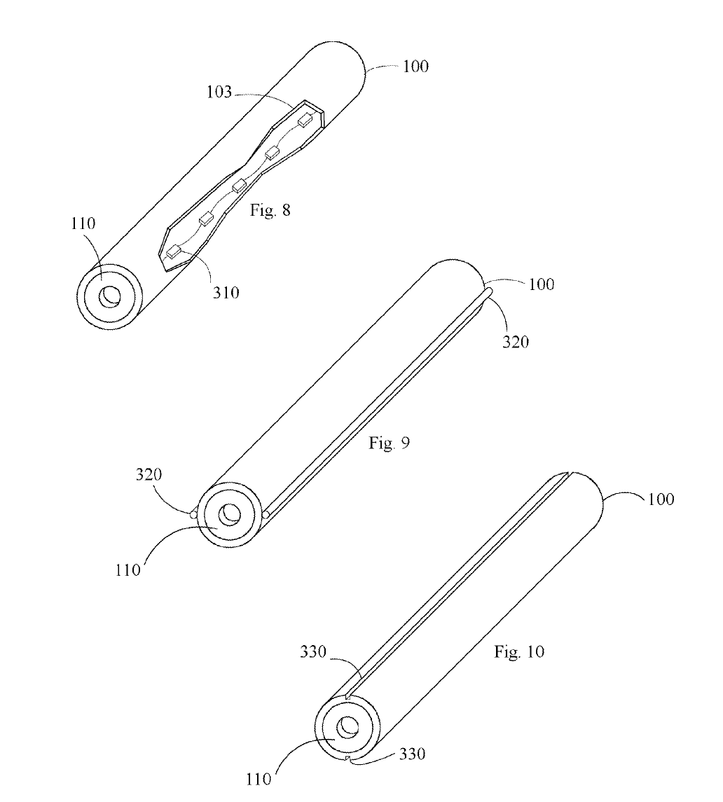

Referring to FIG. 2, an alternate embodiment of a display system of the present invention is shown by mounting one or more display segments 100 on an essentially flat, generally vertical, rotating surface, such as a display in a store. Picture segments on receiver substrate locations on each of the elongated display segments are reassembled to display a picture.

As the rotating, generally vertical surface is rotated 180°, the picture displayed will change from displaying the picture on its “1” right side to displaying the picture on its “2” left side. As the rotating, generally vertical surface is rotated through another 180°, the picture displayed will alternate from displaying the picture on its “2” left side to displaying the picture on its “1” right side. The picture displaying cycle then repeats.

Yet another alternate embodiments has a procedure for mounting the system on non-flat surfaces.

Still another alternate embodiment incorporates the application of one or more known different forces to act on the display segments, such as magnetism, acting on an internal, ferrous mass, which is used simultaneously as a mass to alter its overall center of mass.

There is an alternate embodiment in defining the number of receiver substrate areas, defining four receiver substrate locations around the display segments instead of two. Gravity and magnetism could then be used in conjunction to display one of four images.

An alternate embodiment for affecting the center of mass of the display segments is noted by designing a portion of the display segment to comprise materials of differing densities 105 and 106, thus making one portion of the display segment heavier or lighter than the other. Alternately, hollow display segments can be extruded to have differing wall thicknesses around its circumference yet consistent along its length, giving that portion of the display segment with its thicker walls more mass.

Locating the rotational mechanism 110 has alternate embodiments, as the rotational mechanism may be integral to the display segment, or it may be integral to its mount.

An alternate embodiment provides for display segments with different diameter display segments.

Another embodiment uses transparent tubing which is slid over the display segments and picture sections to attach, secure, and retain the picture sections to the display segments.

Yet another additional embodiment for providing conventional mounts can be established in using mounts which conduct electricity or incorporate electrical conductors for conducting electricity for light generating elements 310, such as a light emitting diode, or powering any subsequent internal devices.

Another embodiment for attachment of picture sections is that they can be removably secured to by any appropriate attachment expedient, such as magnetic backed picture sections and a magnetically attractive surface, by the use of hook and loop material on the backs of the picture sections and on the receiver substrate areas.

An alternate embodiment for attaching the graphic sections is evident in that some picture sections will bear a convenient adhesive layer on their obverse, protected by a strippable liner, where the liner can be pulled away from the picture section, exposing an adhesive surface.

Yet another alternate embodiment is for pictures which are painted or printed onto the receiver substrate areas.

### Operation—Alternate Embodiments

Referring again to FIG. 2, in an alternate embodiment of a display system of the present invention, initial operation starts by providing display segments on an essentially flat, generally vertical, rotating or movable surface 107, then selecting, cutting and attaching picture sections to receiver substrate areas on the display segments. By moving or rotating the movable surface around its central rotation point 108, and stopping the rotation when the display segments are essentially horizontal, different pictures are alternately displayed. The properly displayed, forward facing picture surface could be part of a point-of-purchase display, with alternating messages or images displayed to shoppers.

### CONCLUSION, RAMIFICATION, AND SCOPE

The result of the present invention is a system for displaying one or more pictures mounted on one or more independent, freely rotatable elongated display segments which are attached proximally to each other on a movable surface. The movable surface acts to change the position and orientations of the different display segments with respect to the surface and to nearby display segments, causing a coordinated change of display between one of two different pictures in non-inverted orientations. For example, it correctly displays logos in proper top to bottom orientation on both sides of a concrete mixer drum.

A mounting surface need not be completely flat, but the display segments rotate freely with respect to the mounting surface, taking into account all possible movements of the mounting surface. Each display segment attached to a rotating surface must have free, unobstructed rotation throughout the entire range of motion of the surface.

The display segments must remain generally parallel to each other. They will properly align to display pictures while their axes of rotation are synchronized left sides to left sides, and in a primarily non-vertical orientation. They are not required to be confined to horizontal orientations only, as gravity continues to act on the horizontal component of the center of mass acting on the center of rotation of the display segment to provide a rotational moment when the display segment is not in a true horizontal orientation. However, as the axes of rotation of the display segments approach a vertical orientation, the centers of mass of the display segments become more closely aligned with the axes of rotation, the rotational moment of the horizontal component of gravity on the center of mass acting along the center of rotation approaches zero, and gravity begins to have less effect in providing its novel, desired alignment force on the display segments, and the display coordination breaks down.

While the above description contains many specifications, these should not be construed as limitations on the scope of the invention, but as exemplifications of the presently preferred embodiments thereof. Many other ramifications and variations are possible within the teachings of the invention.

Thus the scope of the invention should be determined by the appended claims and their legal equivalents, and not by the examples given.

I claim:

1. A number of display segments aligned by a force, rotatably mounted to a surface, such that said display segments proximally located display their adjacent image segments on said display segments to reassemble images from said image segments on said display segments in a plurality of non-inverted viewing orientations.

2. A number of display segments aligned by a force, with defined receiver substrate areas for mounting of image segments rotatably mounted to a surface, aligned by said force, such that said display segments proximally located are positioned by said force to display adjacent said images segments on said display segments to reassemble images from said image segments mounted on said receiver substrate areas on said display segments in a plurality of non-inverted viewing orientations.

3. A number of display segments aligned by a force, with defined receiver substrate areas to mount segmented images rotatably mounted to a surface, displaying said segmented images, such that as the said force interacts with said display segments, said receiver receiver substrate areas on said display segments on said surface are aligned in a plurality of non-inverted views to reassemble images from said segmented images mounted on said receiver substrate areas on said display segments.

4. The invention of claim 3 where said surface is a drum.

5. The invention of claim 3 where said surface is flat or essentially flat.

6. The invention of claim 3 where said display segments have cross-sections that are circular.

7. The invention of claim 3 where said force is gravity.
